(19) United States
(12) Patent Application Publication
(10) Pub. No.: US 2010/0301987 A1
(43) Pub. Date: Dec. 2, 2010

(54) MILLIMETER WAVE TRANSFORMER WITH A HIGH TRANSFORMATION FACTOR AND A LOW INSERTION LOSS

(75) Inventors: Didier Belot, Rives (FR); Bernardo Leite, Talence (FR); Eric Kerherve, Talence (FR); Jean-Baptiste Begueret, Merignac (FR)

Correspondence Address: STMicroelectronics Inc.;c/o WOLF, GREENFIELD & SACKS, P.C., 600 Atlantic Avenue, BOSTON, MA, 02210-2206, US

(73) Assignees: STMicroelectronics S.A., Montrouge (FR); CENTRE NATIONAL DE LA RECHERCHE SCIENTIFIQUE, Paris Cedex (FR)

(21) Appl. No.: 12/787,782

(22) Filed: May 26, 2010

(30) Foreign Application Priority Data
May 27, 2009 (FR) 09/53496

(51) Int. Cl. H01F 27/28

(52) U.S. Cl. 336/222

(57) ABSTRACT

A millimeter wave transformer including, at its primary, a turn formed of a conductive track made in at least one first metallization level, and, at its secondary, a winding in front of the primary turn, including at least one turn formed of a conductive track made in at least one second metallization level isolated from the at least one first level, the track width of the primary turn being at least equal to the total width of the secondary winding.

### CROSS REFERENCE TO RELATED APPLICATIONS

This application claims the priority benefit of French patent application Ser. No. 09/53496, filed on May 27, 2009, entitled “MILLIMETER WAVE TRANSFORMER WITH A HIGH TRANSFORMATION FACTOR AND A LOW INSERTION LOSS,” which is hereby incorporated by reference to the maximum extent allowable by law.

### BACKGROUND OF THE INVENTION

1. Field of the Invention

The present invention relates to transformers of A.C. signals at millimeter wavelengths, that is, signals having a frequency ranging between approximately 30 GHz and approximately 300 GHz.

2. Discussion of the Related Art

FIG. 1 shows the electric diagram of a transformer 1. An A.C. signal IN is applied across a primary winding 3. A secondary winding 5, coupled to primary winding 3, provides between its terminals a signal OUT of same frequency as signal IN but of voltage V_{OUT} that may be greater or smaller than voltage V_{IN} of the primary. Transformer 1 is used to raise or lower voltage V_{IN} of input A.C. signal IN, to isolate two circuits from each other, to filter a possible D.C. component of signal IN, or to match the impedances between different components of a circuit. Transformation factor n of transformer 1 determines value V_{OUT} of the output voltage according to rule V_{OUT}=n*V_{IN}. Factor n is a function of value \sqrt{Ls/Lp}, where Ls and Lp are the respective inductances of the secondary and primary windings.

Some applications require transformers capable of processing signals of millimeter wavelengths. This for example concerns, as a non-limiting example, European car radars (80 GHz), or the delivery of high-definition video over wireless networks (60 GHz). At millimeter wavelengths, values Ls and Lp considerably vary with frequency, especially due to the skin effect and to the small thickness of the skin into which a high-frequency signal propagates in a conductor (0.27 μm in copper at 60 GHz). Another issue is the decrease in the transformer resonance frequency, that is, the frequency from which the transformer is no longer operative, as the number of turns of the windings increases. In practice, millimeter wave transformers cannot have more than two turns per winding.

FIG. 2A is a perspective view of a millimeter wave transformer 11. Transformer 11 comprises a primary winding 13, formed of a turn made in a metallization level M1, and a secondary winding 15, formed of two turns essentially made in a same metallization level M2 lower than level M1. The intersection between the two turns forming secondary winding 15 crosses a conductive section 17, formed in a metallization level M3 lower than level M2 and connected to the turns by vias (not shown). Primary winding 13 is arranged above secondary winding 15 so that the average diameter (average of the external diameter and of the internal diameter) of the primary winding coincides with the average diameter of the secondary winding. Conventionally, in the field of integrated circuits comprising passive elements, the primary and secondary windings are formed of conductive tracks having identical widths (for example, 4 μm), formed in successive metallization levels isolated from one another.

FIG. 2B is a cross-section view of transformer 11 of FIG. 2A along a plane schematically shown by line A of FIG. 2A. Primary winding 13 and secondary winding 15 are separated by an isolating layer 19.

A disadvantage of this type of transformers lies in the high insertion loss that they introduce, especially due to the non-negligible resistivity of the windings.

Further, transformation factor n of transformer 11 is determined by inductances Lp and Ls of the primary and secondary windings. Such inductances depend significantly on the operating frequency. It would be desirable, at a given operating frequency, to be able to increase transformation factor n, that is, to increase the ratio between inductances Ls and Lp.

### SUMMARY OF THE INVENTION

Thus, an object of an embodiment of the present invention is to provide a millimeter wave transformer overcoming all or at least some of the above-mentioned disadvantages of prior art solutions.

An object of an embodiment of the present invention is to provide such a transformer having a high transformation factor.

An object of an embodiment of the present invention is to provide such a transformer with a low insertion loss.

Generally, at least one embodiment of the present invention provides a millimeter wave transformer in which the track width of the primary winding is greater than the track width of the secondary winding.

Thus, an embodiment of the present invention provides a millimeter wave transformer comprising at its primary a turn formed of a conductive track made in at least one first metallization level, and at its secondary a winding in front of the primary turn, comprising at least one turn formed of a conductive track made in at least one second metallization level isolated from said at least one first level, the track width of the primary turn being at least equal to the total width of the secondary winding.

According to an embodiment of the present invention, the secondary winding is arranged in front of the external portion of the primary winding, so that the external perimeter of the secondary winding coincides with the external perimeter of the primary winding.

According to an embodiment of the present invention, the secondary winding comprises two turns formed in said at least one second metallization level, the intersection between these two turns being formed in a third metallization level isolated from the first level.

According to an embodiment of the present invention, the conductive tracks are copper tracks.

An embodiment of the present invention provides a method for adjusting the transformation factor of a millimeter wave transformer comprising at its primary a turn formed of a conductive track made in at least one first metallization level, and at its secondary a winding in front of the primary turn, comprising at least one turn formed of a conductive track made in at least one second metallization level isolated from said at least one first level, the track width of the primary turn being greater than the total width of the secondary winding, the method comprising a step of adjustment of the position of the secondary winding, towards the outer portion of the primary turn to increase said factor and towards the inner portion of the primary winding to decrease said factor.

The foregoing objects, features, and advantages of the present invention will be discussed in detail in the following non-limiting description of specific embodiments in connection with the accompanying drawings.

### BRIEF DESCRIPTION OF THE DRAWINGS

FIG. 1, previously described, shows the electric diagram of a transformer;

FIG. 2A, previously described, is a perspective view of a millimeter wave transformer;

FIG. 2B, previously described, is a cross-section view of the transformer of FIG. 2A;

FIG. 3A is a perspective view showing an example of a millimeter wave transformer according to an embodiment of the present invention;

FIG. 3B is a cross-section view of the transformer of FIG. 3A;

FIGS. 4A and 4B show the variations of the transformation factor and of the insertion loss versus the frequency of the input signal for the transformers of FIGS. 2A and 3A;

FIG. 5A is a perspective view showing an example of a millimeter wave transformer according to another embodiment of the present invention;

FIG. 5B is a cross-section view of the transformer of FIG. 5A;

FIG. 6A is a perspective view of an example of a millimeter wave transformer according to another embodiment of the present invention;

FIG. 6B is a cross-section view of the transformer of FIG. 6A; and

FIG. 7 shows the variation of the transformation factor versus the frequency of the input signal for the transformers of FIGS. 5A and 6A.

### DETAILED DESCRIPTION

For clarity, the same elements have been designated with the same reference numerals in the different drawings and, further, as usual in the representation of integrated circuits, the various drawings are not to scale.

FIG. 3A is a perspective view of a millimeter wave transformer 21. Transformer 21 comprises a primary winding 23, formed of a turn made in a metallization level M1, and a secondary winding 25, formed of two turns essentially made in a same metallization level M2 lower than level M1. The intersection between the two turns forming secondary winding 25 crosses a conductive section 27, formed in a metallization level M3 lower than level M2 and connected to the turns by vias (not shown). Primary winding 23 is arranged above secondary winding 25, so that the average diameter (average of the external diameter and of the internal diameter) of the primary winding coincides with the average diameter of the secondary winding.

FIG. 3B is a cross-section view of transformer 21 of FIG. 3A along a plane schematically shown by line A of FIG. 3A. The conductive tracks are separated from one another by an isolator 29.

As illustrated, the track width of primary winding 23 is greater than the track width of secondary winding 25. According to an embodiment illustrated in FIGS. 3A and 3B, the track width of primary winding 23 is greater than the total width of secondary winding 25, that is, in this case, twice the track width of the secondary winding plus the width of isolator 29 comprised between the first and the second turn of the secondary winding. One may for example select a track width of 12 μm for primary winding 23, a track width of 4 μm for secondary winding 25, and a 1.5-μm isolator width 29 between the first and the second turn of the secondary winding.

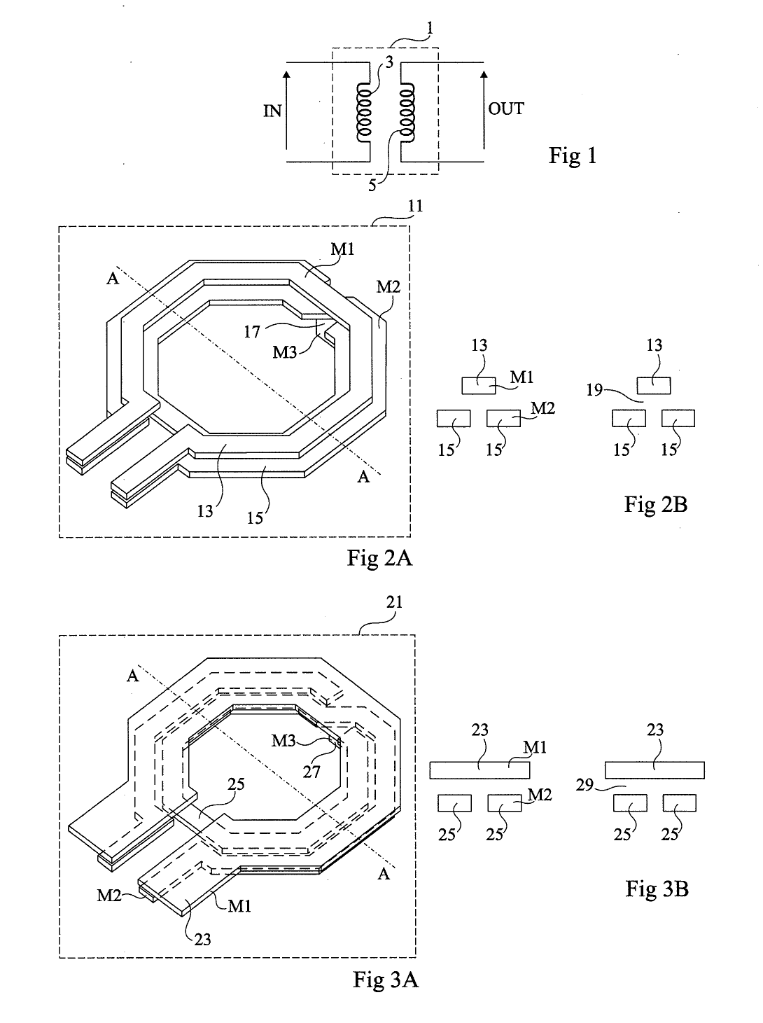

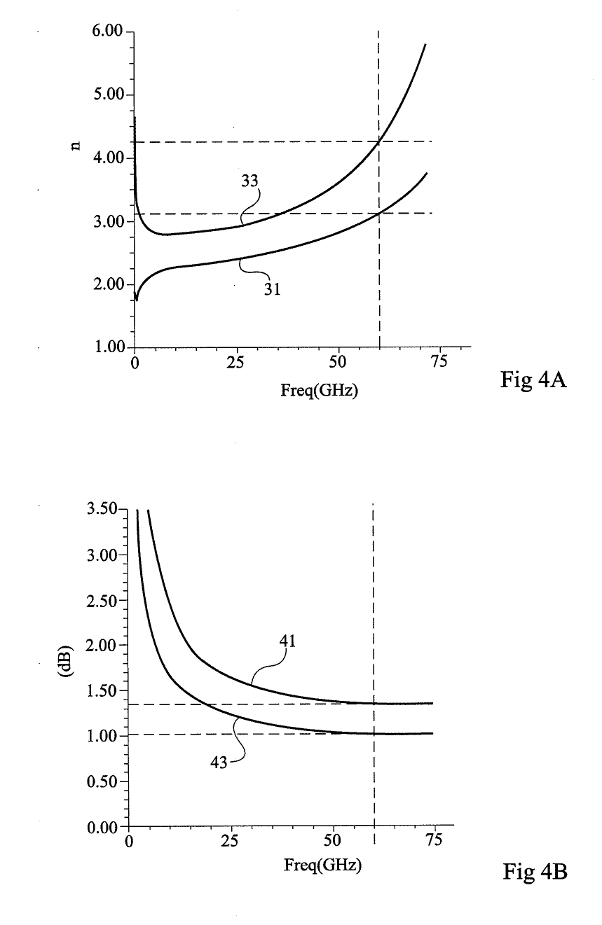

FIG. 4A shows the variation of transformation factors n of the transformers illustrated in FIGS. 2A-2B and 3A-3B according to the frequency of the input signal. Curve 31 corresponds to the case of transformer 11 of FIGS. 2A and 2B, for track widths of the primary and secondary windings equal to 4 μm. Curve 33 corresponds to the case of transformer 21 of FIGS. 3A and 3B, for track widths of the primary and secondary windings respectively equal to 12 μm and 4 μm.

Curve 33 is located clearly under curve 31, whatever the considered operating frequency, and especially for signals of millimeter wavelength. For example, at 60 GHz, the transformation factor of transformer 11 is equal to 3.11 and that of transformer 21 is equal to 4.24.

FIG. 4B shows the variation of transformation factor n of transformers 11 and 21, according to the input signal frequency. Curve 41 corresponds to the case of transformer 11, for track widths of the primary and secondary windings equal to 4 μm. Curve 43 corresponds to the case of transformer 21, for track widths of the primary and secondary windings respectively equal to 12 μm and 4 μM.

Curve 43 is located clearly under curve 41, whatever the considered operating frequency, and especially for signals of millimeter wavelength. For example, at 60 GHz, the insertion loss of transformer 11 is 1.33 dB and that of transformer 21 are of 1.01 dB.

It should be noted that the increase of the track width of the primary winding is only advantageous short of a given threshold. Indeed, beyond a given length, a degradation of the transformer performances and especially an increase of the insertion loss can be observed. For example, if the secondary winding is formed of two turns having a 4-μm track width, separated by 1.5 μm of isolator, that is, with a total width of 9.5 μm, it should be ascertained not to increase the track width of the primary winding beyond 24 μm.

When the track width of the primary winding is greater than the total width of the secondary winding, different positionings of the secondary winding in front of the primary winding are possible.

According to an aspect of the present invention, the secondary winding is positioned under the external portion of the primary winding, so that its external perimeter coincides with the external perimeter of the primary winding.

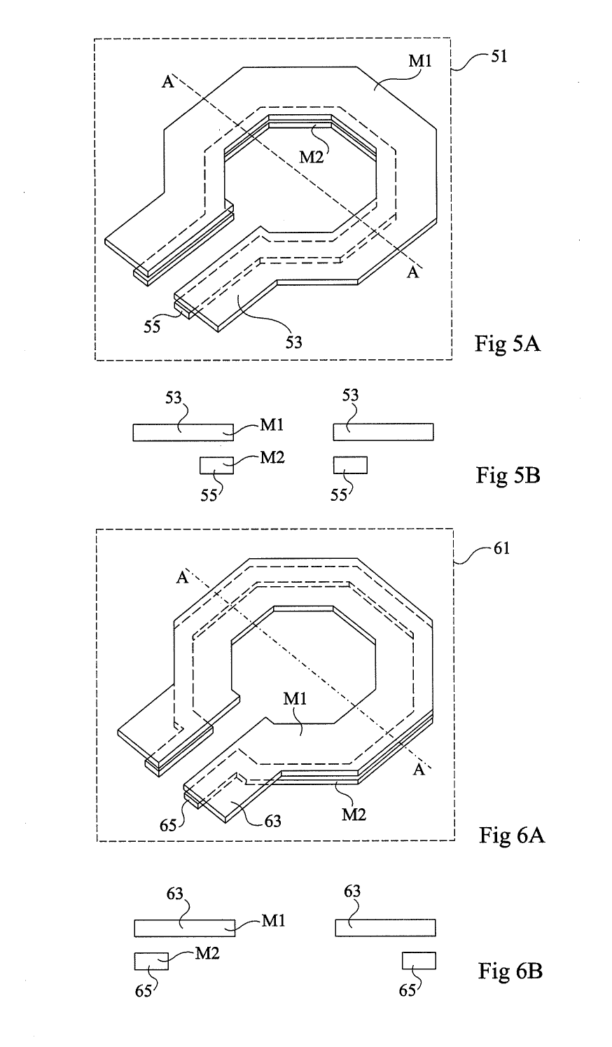

FIG. 5A is a perspective view showing a millimeter wave transformer 51. Transformer 51 comprises a primary winding 53, formed of a turn made in a metallization level M1, and a secondary winding 55 formed of a turn made in a metallization level M2 lower than level M1. Primary winding 53 is arranged in front of secondary winding 55, so that the internal perimeters of the primary and secondary windings coincide.

FIG. 5B is a cross-section view of transformer 51 of FIG. 5A along a plane schematically shown by line A of FIG. 5A.

FIG. 6A is a perspective view showing a millimeter wave transformer 61. Transformer 61 comprises a primary winding 63, formed of a turn made in a metallization level M1, and a secondary winding 65 formed of a turn made in a metallization level M2 lower than level M1. Primary winding 63 is arranged in front of secondary winding 65, so that the external perimeters of the primary and secondary windings coincide.

FIG. 6B is a cross-section view of transformer 61 of FIG. 6A along a plane schematically shown by line A of FIG. 6A.

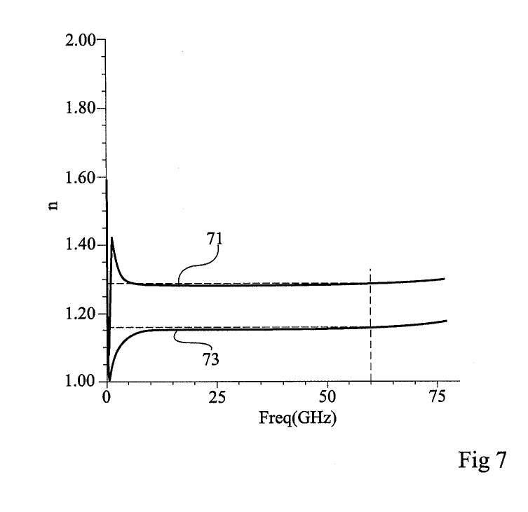

FIG. 7 shows the variation of transformation factor n of the transformers illustrated by FIGS. 5A-5B and 6A-6B according to the frequency of the input signal. Curves 71 and 73 respectively correspond to transformers 51 (FIGS. 5A and 5B) and 61 (FIGS. 6A and 6B), for track widths of the primary and secondary windings respectively equal to 12 μm and 4 μm.

Curve 73 is located clearly under curve 71, whatever the considered operating frequency, and especially for signals of millimeter wavelength. For example, at 60 GHz, the transformation factor of transformer 51 is equal to 1.16 and that of transformer 61 is equal to 1.28.

The present inventors have determined that, for a given primary winding diameter, the transformation factor increases linearly with the diameter of the secondary winding, when the latter is within the range of values for which the primary and secondary windings are in front of each other.

Thus, to increase the transformation factor, it is provided to arrange the secondary winding under the external portion of the primary winding, so that the external perimeters of the windings coincide, as illustrated in FIG. 6A.

According to an advantage of the present invention, it is possible to finely adjust the transformation factor to the specified needs by adequately positioning the secondary winding towards the inside or towards the outside of the primary winding.

Specific embodiments of the present invention have been described. Various alterations and modifications will readily occur to those skilled in the art. In particular, the present invention is not limited to the above-discussed examples of millimeter transformers in which the secondary windings comprise one or two turns. It will be within the abilities of those skilled in the art to implement the present invention whatever the number of turns of the secondary winding (in practice, no more than two turns for frequencies greater than 50 GHz). Further, numerical track width values have been given as an example. The present invention is not limited to these sole specific cases. Further, the use of copper conductive tracks has been mentioned. The present invention is not limited to this sole specific case. It will be within the abilities of those skilled in the art to implement the present invention whatever the materials used to form the transformer. Further, metallization levels lower or greater than other metallization levels have been mentioned in the description of embodiments of the present invention, and the primary windings have especially been described as been arranged above the secondary windings. The present invention is not limited to these sole specific cases. The order of the metallization levels may be inverted and, in particular, the secondary windings may be arranged above the primary winding.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A millimeter wave transformer comprising, at its primary, a turn formed of a conductive track made in at least one first metallization level and, at its secondary, a winding in front of the primary turn, this secondary winding comprising at least one turn formed of a conductive track made in at least one second metallization level isolated from said at least one first level, the track width of the primary turn being larger than the width of a turn of the secondary winding and at least equal to the total width of the secondary winding.

2. The transformer of claim 1, wherein the secondary winding is arranged in front of the external portion of the primary turn, so that the external perimeter of the secondary winding coincides with the external perimeter of the primary winding.

3. The transformer of claim 1, wherein the secondary winding comprises two turns formed in said at least one second metallization level, the intersection between these two turns being formed in a third metallization level isolated from the first level.

4. The transformer of claim 1, wherein the conductive tracks are copper tracks.

5. A method for adjusting the transformation factor of a millimeter wave transformer comprising at its primary a turn formed of a conductive track made in at least one first metallization level, and at its secondary a winding in front of the primary turn, comprising at least one turn formed of a conductive track made in at least one second metallization level isolated from said at least one first level, the track width of the primary winding being greater than the total width of the secondary winding, the method comprising a step of adjustment of the position of the secondary winding, towards the outer portion of the primary turn to increase said factor and towards the inner portion of the primary winding to decrease said factor.
